(19) United States
(12) Patent Application Publication
(10) Pub. No.: US 2008/0270453 A1
(43) Pub. Date: Oct. 30, 2008

(54) KEYWORD-BASED CONTENT MANAGEMENT

(75) Inventors: Tan Quang Bui, Aliso Viejo, CA (US); Linh Phuong Dinh Kochan, Newport Coast, CA (US); Hong Quang Bui, Laguna Niguel, CA (US)

Correspondence Address: BLACK LOWE & GRAHAM, PLLC, 701 FIFTH AVENUE, SUITE 4800, SEATTLE, WA, 98104, US

(73) Assignee: Memeo, Inc., Aliso Viejo, CA (US)

(21) Appl. No.: 12/104,151

(22) Filed: Apr. 16, 2008

Related U.S. Application Data
(60) Provisional application No. 60/912,059, filed on Apr. 16, 2007.

(51) Int. Cl. G06F 7/00

(52) U.S. Cl. 707/102; 707/E17.044

(57) ABSTRACT

A method, implementable in a system coupled to a network, includes accessing a first portion of a memory device coupled to the network. The first portion has stored thereon a plurality of data sets. A plurality of discrete alphanumeric strings associated with each data set of the plurality is identified. A listing of the data sets is stored in a second portion of a memory device coupled to the network. Each respective data set is cross-referenced in the listing to a respective set of alphanumeric strings including only those alphanumeric strings identified as being associated with the respective data set. After storing the data-set listing, a first alphanumeric keyword is received from a user. A first set of the data sets is identified from the listing. Each data set of the first data-set set includes the first keyword. In response to identifying the first data-set set, the first data-set set is automatically stored in a third portion of a memory device coupled to the network.

### CROSS-REFERENCE TO RELATED APPLICATIONS

This application claims priority to U.S. Provisional Appl. No. 60/912,059 entitled “USING KEYWORDS TO DETERMINE BACKUP OR SYNCHRONIZE” and filed Apr. 16, 2007, which is hereby incorporated by reference in its entirety.

### FIELD OF THE INVENTION

This invention relates generally to computer-implemented processes and, more specifically, to content management in electronic devices.

### BACKGROUND OF THE INVENTION

As computers become an increasingly ubiquitous tool, people are creating and storing more and more different kinds of data on their hard disks. Tax returns, financial records, letters, address books, photos, and digital music all have varying levels of sentimental, financial, and utilitarian value. However, traditional backup programs treat all of these files in the same manner, regardless of sensitivity and/or value to the user.

Existing backup software typically requires the user's periodic interaction, usually to insert a new disc or tape or to initiate a network connection. Because this interaction is not initiated by the user and offers no immediate perceived value, it is often an unwanted chore. As such, existing data backup systems do not adequately help users protect themselves from data loss because they treat all data the same, thereby preventing the user from being able to treat data with different levels of care. Additionally, locating and assessing a desired storage destination for varying file types can likewise be a tedious and unwanted chore.

Other problems with the prior art not described above can also be overcome using the teachings of embodiments of the present invention, as would be readily apparent to one of ordinary skill in the art after reading this disclosure.

### SUMMARY OF THE INVENTION

In an embodiment, a method, implementable in a system coupled to a network, includes accessing a first portion of a memory device coupled to the network. The first portion has stored thereon a plurality of data sets. A plurality of discrete alphanumeric strings associated with each data set of the plurality is identified. A listing of the data sets is stored in a second portion of a memory device coupled to the network. Each respective data set is cross-referenced in the listing to a respective set of alphanumeric strings including only those alphanumeric strings identified as being associated with the respective data set. After storing the data-set listing, a first alphanumeric keyword is received from a user. A first set of the data sets is identified from the listing. Each data set of the first data-set set includes the first keyword. In response to identifying the first data-set set, the first data-set set is automatically stored in a third portion of a memory device coupled to the network.

### BRIEF DESCRIPTION OF THE DRAWING

Preferred and alternative embodiments of the present invention are described in detail below with reference to the following drawings.

FIG. 1 is a schematic view of an exemplary operating environment in which an embodiment of the invention can be implemented;

FIG. 2 is a functional block diagram of an exemplary operating environment in which an embodiment of the invention can be implemented; and

FIG. 3 is an illustration of a process according to an embodiment of the invention.

### DETAILED DESCRIPTION OF THE PREFERRED EMBODIMENT

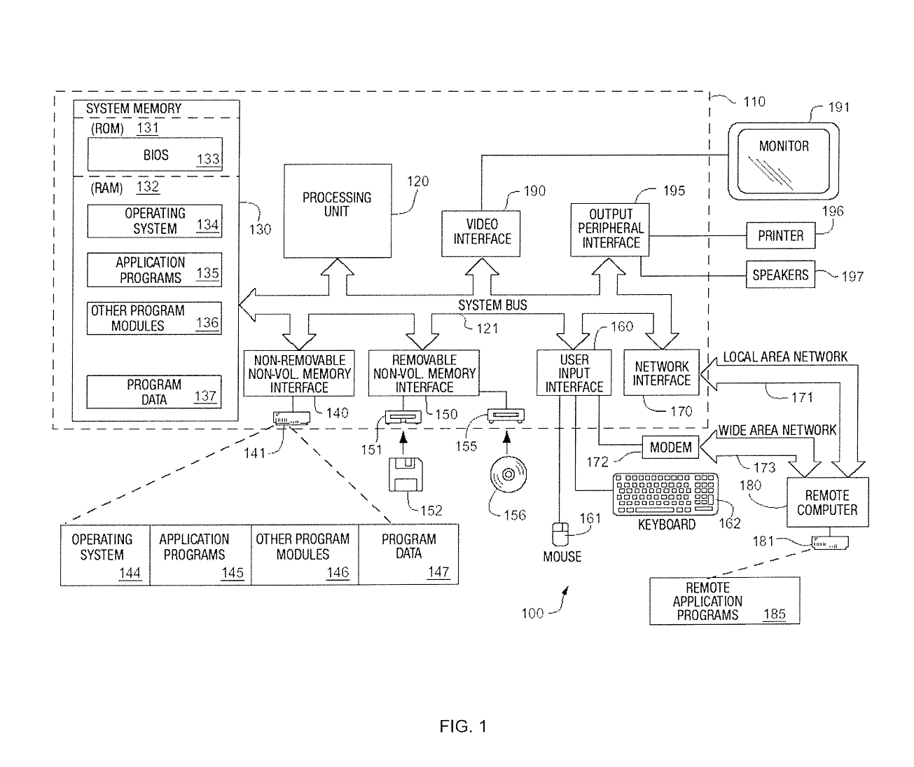

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 1 10 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

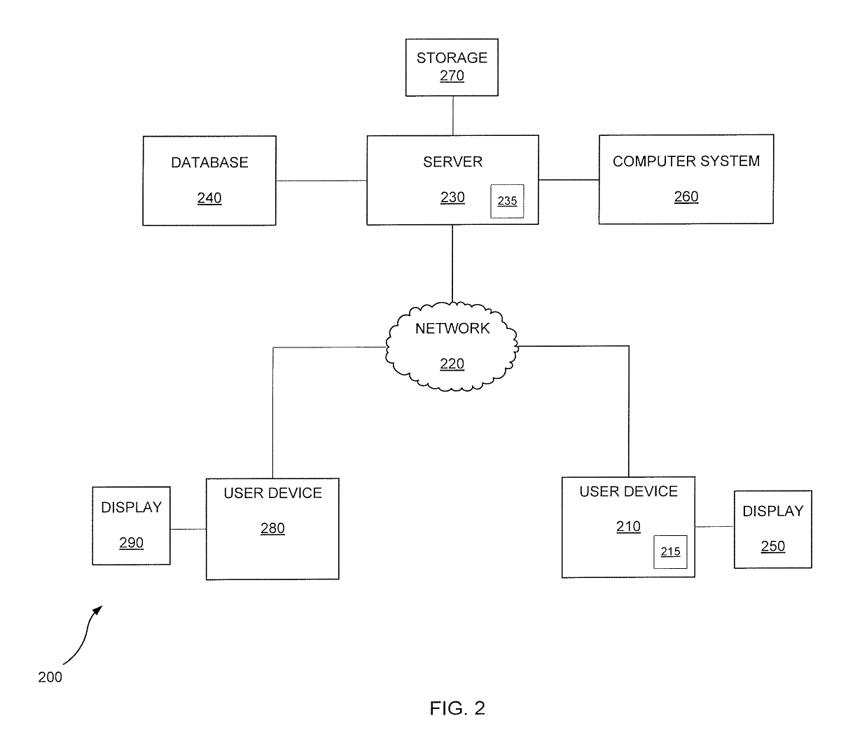

Referring now to FIG. 2, an embodiment of the present invention can be described in the context of an exemplary computer network system 200 as illustrated. System 200 includes electronic user devices 210, 280, such as personal computers, workstations or other processing devices (e.g., personal digital assistants), that are linked via a communication medium, such as a network 220 (e.g., the Internet), to an electronic device or system, such as a server 230. The server 230 may further be coupled, or otherwise have access, to a database 240, electronic storage 270 and a computer system 260. Although the embodiment illustrated in FIG. 2 includes one server 230 coupled to two user devices 210, 280 via the network 220, it should be recognized that embodiments of the invention may be implemented using two or more such user devices coupled to one or more such servers.

In an embodiment, each of the user devices 210, 280 and server 230 may include all or fewer than all of the features associated with the computer 110 illustrated in and discussed with reference to FIG. 1. User devices 210, 280 may include or may be otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

Embodiments of the invention may include software applications that utilize an index-search engine to retrieve, based on one or more keywords, a list of files to enable backup, syncing, and/or sharing of such files.

Embodiments of the invention may include software applications, executable by one or more of the user devices 210, 280 and server 230, that enable backup, synching, sharing, and/or management of data that contain one or more keyword(s) that are stored in an index table created by such an embodiment. Embodiments of the invention manage and/or organize all or some digital content stored at different locations by using keywords stored in the index table.

Embodiments of the invention may:

Backup a file to a designated location—a set of files are copied to a specific location for storage and may not be for distribution. This may be known as one-way syncing.

Sync file between locations—a set of files at two different locations may be made to have identical files. This may be known as two-way syncing.

Share file over internet—a set of files are distributed to the web or otherwise over a network for sharing. For example, new parents can distribute their baby pictures to friends and family for viewing. As used herein, the term “storing” may mean any of such backup, syncing and sharing.

Embodiments of the invention do not require the managed data (folders, files, images, etc.) to be at a certain location or in a certain format.

The alphanumeric strings associated with (e.g., text in a main body of a file, metadata, etc.) digital content/files can be used as keywords by different applications to perform operations such as backup, synching, sharing, and/or management of all or some digital content stored at different locations.

An advantage associated with an embodiment may be optimization. The speed and/or performance of finding relevant documents in response to a search query is enhanced. With prior-art approaches, the query may result in a scan of every document on a user device, which would take a considerable amount of time and consume CPU resources.

In traditional backup or synchronize applications, the file location must be selected to perform the backup, sync, or share. The user must know where the files are located. In an embodiment, user doesn't have to know or provide the location of the files. Any files that are relevant to the keyword can be backed up, synchronized, or shared.

For example, a user of the user device 210 may instruct an application 215 executed by the user device 210 to access a memory portion of the user device 280 and parse all, or a user-defined set, of the digital files (data sets) stored in the memory portion of the user device 280. Alternatively, the user of the user device 210 may instruct an application 215 executed by the user device 210 to access a memory portion of the user device 210 and parse all, or a user-defined set, of the digital files stored in the memory portion of the user device 210. Still alternatively, the user may instruct a web-based application 235 executed by the server 230 to perform one or more of the accessing and parsing functions described above. For the sake of brevity, it should be noted that all functionality described herein with respect to the application 215 should likewise be ascribed to application 235.

The files parsed by the application 215 may be of a format included in the following non-limiting list of formats:

Office document—e.g., formats associated with all Microsoft® products, PDF, etc.

Music and/or Audio—e.g., MP3, MP4, WAV, AVI, WMA, etc.

Video—e.g., WMV, MOV, MPG, MPEG, etc.

Graphic—e.g., JPG, GIF, PNG, etc.

Compressed file—e.g., ZIP, RAR, CAB, GZIP, BZIP, TAR, etc.

In parsing the digital files, the application 215 may, for example, scan the root (e.g., C:\) drive or a given directory of a local drive for all files or a user-defined set of files. Each file may be parsed for its associated alphanumeric content, be it in a body of text, associated metadata, file name, or the like.

Once each of the files has been parsed, each alphanumeric string (e.g., word) identified as being associated with a parsed file may then be stored by the application 215 in an index table (not shown), or other structured data arrangement/listing, which may be stored in a memory device associated with or otherwise coupled to server 230, one or more of user devices 210, 280, or other location. Additionally, the name or other identifier of each parsed file is stored in the index table in such manner that each such file name is cross-referenced with the alphanumeric strings associated with the corresponding parsed file. Consequently, for any given term appearing in any of the parsed files, the index table is configured to indicate all parsed files that contain or are otherwise associated with the given term. Notably, in an embodiment, a search term or keyword is not required to construct the index table.

Once the index table has been constructed and stored, the application 215 may be configured to receive from the user, via, for example, a graphical user interface (not shown), one or more keywords indicating files of interest to the user. In response to receiving the keyword, the application 215 can automatically consult the index table to determine a set of the files listed therein, each file of the set containing or otherwise associated with the keyword. As used herein, a process that is performed “automatically” may mean that the process is performed as a result of machine-executed instructions and does not, other than the establishment of user preferences, require manual effort.

After identifying the set of files associated with the keyword, the application 215 can automatically act on files of the set based on a predetermined set of user preferences. For example, a user may have previously specified that all files that contain a certain term/keyword (be it in a body of text, associated metadata, file name, or the like) be moved or copied to a corresponding folder at a designated memory location associated with the network system 200. Additionally, a user may have previously specified that only files that contain a certain combination of terms be moved or copied to a corresponding folder at a designated memory location associated with the network system 200. Additionally, a user may have previously specified that all files that contain a certain date be moved or copied to a calendar application associated with the network system 200 so as to set up an event viewable in the calendar and associated with that date. Additionally, a user may have previously specified that all files that contain a certain term be emailed or otherwise forwarded to a designated recipient. In each such case, or combination thereof, the application 215 can automatically perform the desired predetermined act.

Additionally, the keyword-search and action functionality described above can be implemented as an ongoing process applied to newly created, modified and/or received files. For example, if a file is created that includes, or an existing file is modified to include, a particular keyword, then an embodiment, which can be configured to periodically poll stored files for keywords contained therein, can automatically subsequently update the index table correspondingly and/or perform an appropriate predetermined action on such file.

In case of a potential or actual conflict between or among predetermined user-prescribed actions with respect to a file (e.g., the file contains multiple keywords that would precipitate two or more conflicting dispositions of the file), an embodiment can be configured to store copies of the file to all destinations associated with applicable actions. Alternatively, an embodiment can be configured to perform a single action with respect to the file based on a predetermined priority hierarchy, which may be established by the user. For example, the user may express, and an embodiment may give effect to, a desire that files containing a certain keyword be stored in a single location, regardless of any other keyword(s) that the file may contain.

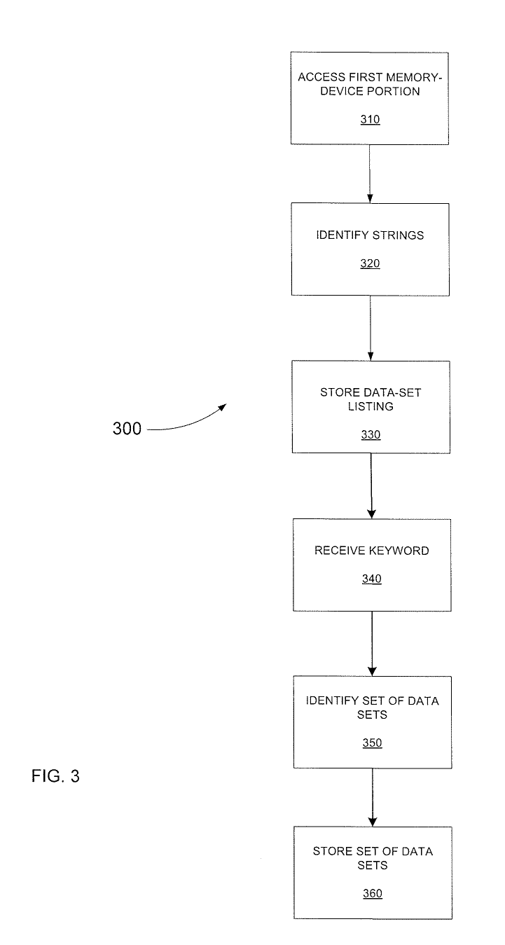

FIG. 3 illustrates a process 300 according to an embodiment of the invention. The process 300 is implementable in an electronic system coupled to or including a storage device and/or a network. The process 300 is illustrated as a set of operations shown as discrete blocks. The process 300 may be implemented in any suitable hardware, software, firmware, or combination thereof. The process 300 may be implemented in computer-readable instructions that can be sent from one electronic device to another over a network. The order in which the operations are described is not to be necessarily construed as a limitation.

At a block 310, a first portion of a memory device coupled to the network is accessed. The first portion has stored thereon a plurality of data sets. For example, a user of the user device 210 may instruct an application 215 executed by the user device 210 to access a memory portion of the user device 280 and parse all, or a user-defined set, of the digital files (data sets) stored in the memory portion of the user device 280. Alternatively, the user of the user device 210 may instruct an application 215 executed by the user device 210 to access a memory portion of the user device 210 and parse all, or a user-defined set, of the digital files stored in the memory portion of the user device 210. Still alternatively, the user may instruct a web-based application 235 executed by the server 230 to perform one or more of the accessing and parsing functions described above.

At a block 320, a plurality of discrete alphanumeric strings associated with each data set of the plurality of data sets is identified. For example, each file may be parsed for its associated alphanumeric content, be it in a body of text, associated metadata, file name, or the like.

At a block 330, a listing of the data sets is stored in a second portion of a memory device coupled to the network. Each respective data set is cross-referenced in the listing to a respective set of alphanumeric strings including only those alphanumeric strings identified as being associated with the respective data set. For example, once each of the files has been parsed, each alphanumeric string (e.g., word) identified as being associated with a parsed file may then be stored by the application 215 in an index table, or other structured data arrangement/listing, which may be stored in a memory device associated with or otherwise coupled to server 230, one or more of user devices 210, 280, or other location. Additionally, the name or other identifier of each parsed file is stored in the index table in such manner that each such file name is cross-referenced with the alphanumeric strings associated with the corresponding parsed file. Consequently, for any given term appearing in any of the parsed files, the index table is configured to indicate all parsed files that contain or are otherwise associated with the given term. Notably, in an embodiment, a search term or keyword is not required to construct the index table.

At a block 340, after storing the data-set listing, a first alphanumeric keyword is received from a user. For example, once the index table has been constructed and stored, the application 215 may be configured to receive from the user, via, for example, a graphical user interface, one or more keywords indicating files of interest to the user.

At a block 350, a first set of the data sets is identified from the listing. Each data set of the first set of the data sets includes the first keyword. For example, in response to receiving the keyword, the application 215 can automatically consult the index table to determine a set of the files listed therein, each file of the set containing or otherwise associated with the keyword.

At a block 360, in response to identifying the first data-set set, the first data-set set is automatically stored in a third portion of a memory device coupled to the network. For example, after identifying the set of files associated with the keyword, the application 215 can automatically act on files of the set based on a predetermined set of user preferences. For example, a user may have previously specified that all files that contain a certain term/keyword (be it in a body of text, associated metadata, file name, or the like) be moved or copied to a corresponding folder at a designated memory location associated with the network system 200. Additionally, a user may have previously specified that only files that contain a certain combination of terms be moved or copied to a corresponding folder at a designated memory location associated with the network system 200. Additionally, a user may have previously specified that all files that contain a certain date be moved or copied to a calendar application associated with the network system 200 so as to set up an event viewable in the calendar and associated with that date. Additionally, a user may have previously specified that all files that contain a certain term be emailed or otherwise forwarded to a designated recipient. In each such case, or combination thereof, the application 215 can automatically perform the desired predetermined act.

While a preferred embodiment of the invention has been illustrated and described, as noted above, many changes can be made without departing from the spirit and scope of the invention. Instead, the invention should be determined entirely by reference to the claims that follow.

The embodiments of the invention in which an exclusive property or privilege is claimed are defined as follows:

1. A computer-readable medium having computer-executable instructions that, when executed in a system coupled to a network, enable the system to perform a method comprising at least the steps of:
automatically accessing a first portion of a memory device coupled to the network, the first portion having stored thereon a plurality of data sets;
automatically identifying a plurality of discrete alphanumeric strings associated with each data set of the plurality;
automatically storing in a second portion of a memory device coupled to the network a listing of the data sets, each respective data set being cross-referenced in the listing to a respective set of alphanumeric strings comprising only those alphanumeric strings identified as being associated with the respective data set;
after storing the data-set listing, receiving from a user a first alphanumeric keyword;
automatically identifying from the listing a first set of the data sets, each data set of the first data-set set including the first keyword; and
in response to identifying the first data-set set, automatically storing the first data-set set in a third portion of a memory device coupled to the network.

2. The medium of claim 1 wherein the third memory-device portion is selected for storage of the first data-set set by the user.
